(19) United States
(12) Patent Application Publication
(10) Pub. No.: US 2010/0202608 A1
(43) Pub. Date: Aug. 12, 2010

(54) ENCRYPTION DEVICE, DECRYPTION DEVICE, AND STORAGE DEVICE

(75) Inventor: Kana FURUHASHI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/702,184

(22) Filed: Feb. 8, 2010

(30) Foreign Application Priority Data
Feb. 10, 2009 (JP) 2009-029022

(51) Int. Cl. G06F 12/14; H04L 9/00

(52) U.S. Cl. 380/44; 380/277; 713/193; 711/E12.092

(57) ABSTRACT

According to one embodiment, an encryption device uses N extended keys (N: a natural number not less than 2) obtained by extending one encryption key, and includes a first memory, a comparison circuit, a second memory, a selector, and an extension calculator. The first memory stores a flag corresponding to an initial value of a key. The comparison circuit outputs a signal indicating comparison matching when a command and the key are related to encryption. The selector loads the key in the first memory into the second memory upon receiving the signal. The extension calculator calculates the extended keys based on the key in the second memory and inputs them to the selector. Except when loading the initial value of the key into the second memory, the selector loads the extended keys into the second memory to extend the encryption key to from the first to N-th extended keys.

### CROSS-REFERENCE TO RELATED APPLICATIONS

This application is based upon and claims the benefit of priority from Japanese Patent Application No. 2009-029022, filed Feb. 10, 2009, the entire contents of which are incorporated herein by reference.

### BACKGROUND

1. Field

One embodiment of the invention relates to an encryption device, a decryption device, and a storage device, and more particularly, to an encryption device, a decryption device, and a storage device using an advanced encryption standard scheme.

2. Description of the Related Art

FIG. 1 illustrates an encryption process using an advanced encryption standard (AES) scheme. In the encryption process using the AES scheme, N (N: a natural number not less than 2) extended keys obtained by extending one encryption key called encryption key schedule are sequentially used in data processing. For example, when the length of the encryption key is 256 bits, N=15 extended keys are sequentially used in data processing. When encryption is performed, the N extended keys are sequentially used in the order of the first to N-th extended keys.

For example, an encryption process with respect to a plain text or a ciphertext of 128 bits is performed in the following manner.

E1: An extended key 1 of 128 bits is calculated from the encryption key of 256 bits.

E2: Data of 128 bits when a first round is completed is calculated from the plain text of 128 bits and the extended key 1 of 128 bits.

E3: An extended key 2 of 128 bits is calculated from the encryption key of 256 bits or the extended key 1 of 128 bits. The extended key 1 and the extended key 2 correspond to the encryption key.

E4: Data of 128 bits when a second round is completed is calculated from the data of 128 bits when the first round is completed and the extended key 2 of 128 bits.

E5: The same process as above is repeated until an N-th round is completed, and data of 128 bits when the N-th round is completed becomes a ciphertext.

FIG. 2 illustrates a decryption process using the AES scheme. When decryption is performed, the N extended keys are used in reverse order of the sequence of encryption, i.e., in the order of the N-th to first extended keys.

For example, a decryption process with respect to the ciphertext of 128 bits is performed in the following manner.

D1: A decryption key of 256 bits, i.e., the extended key N of 128 bits and the extended key N−1 of 128 bits are calculated. The encryption keys N and N−1 correspond to the decryption key.

D2: Data of 128 bits when the (N−1)-th round is completed is calculated from the ciphertext of 128 bits and the extended key N of 128 bits.

D3: The extended key N−1 of 128 bits is calculated from the extended key N of 128 bits.

D4: Data of 128 bits when the (N−2)-th round is completed is calculated from the data of 128 bits when the (N−1)-th round is completed and the extended key (N−1) of 128 bits.

D5: The same process as above is repeated until the 0-th round is completed, and data of 128 bits when the 0-th round is completed becomes a plain text (decrypted text).

In the encryption process and the decryption process, initial values of the extended keys are different from each other. For this reason, when the key extension (so-called On-The-Fly key extension) is performed during the encryption process, the extended keys need to be initialized before the encryption process. Similarly, when the key extension is performed during the decryption process, the extended keys need to be initialized before the decryption process.

Meanwhile, since the process directions of the encryption and the decryption of the AES scheme are frequently switched, overhead at setting the initial values preferably does not exist each time a processor, such as a central processing unit (CPU), switches encryption and decryption. According to encryption modes (Cipher Modes of Operation), an encryption process is performed when an initialization vector used in the encryption or the decryption is generated. Therefore, the process direction may be continuously switched in such a manner as decryption, encryption, and decryption in a one-time start. Even in this case, overhead at setting the initial values preferably does not exist.

FIG. 3 illustrates an example of a conventional encryption/decryption device. For convenience of explanation, it is assumed that the key length of an encryption key and a decryption key is 256 bits. The encryption/decryption device comprises a key extension circuit illustrated in FIG. 3 and an engine (not illustrated) of an AES scheme that performs an encryption process and a decryption process of the AES scheme.

First, a CPU 10 sets an extended key 1 and an extended key 2 to a memory 11 and sets an extended key N−1 and an extended key N to a memory 12. A selector 13 selectively outputs the extended keys in the memory 11 or 12 to a selector 14 according to an encryption command or a decryption command. When the encryption process is performed, the selector 13 selectively outputs the extended key 1 and the extended key 2 (i.e., encryption key) to the selector 14 according to the encryption command from the CPU 10. When the decryption process is performed, the selector 13 selectively outputs the extended key N−1 and the extended key N (i.e., decryption key) to the selector 14 according to the decryption command from the CPU 10.

The selector 14 loads the encryption key as an initial value into a memory 15 according on the encryption command and a trigger signal instructing the loading of the initial value into the memory 15, and loads the decryption key as an initial value into the memory 15 according to the decryption command and the trigger signal. An encryption extension calculator 16 sequentially calculates the extended keys based on the encryption key in the memory 15, when the encryption process is performed. A decryption extension calculator 17 sequentially calculates the extended keys based on the decryption key in the memory 15, when the decryption process is performed. In the case other than when the initial value of the key is loaded into the memory 15, the selector 14 loads the extended keys calculated by the encryption extension calculator 16 into the memory 15 according to the encryption command, and loads the extended keys calculated by the decryption extension calculator 17 into the memory 15 according to the decryption command. Therefore, when the encryption process is performed, the encryption key is extended in the order of the extended keys 1 to N, and when the decryption process is performed, the decryption key is extended in the order of the extended keys N to 1. The selector 14, the memory 15, the encryption extension calculator 16, and the decryption extension calculator 17 form a key extension calculation circuit 18.

The engine (not illustrated) of the AES scheme performs the encryption process using the extended keys stored in the memory 15 with respect to the plain text according to the encryption command, and generates a ciphertext. The engine of the AES scheme performs the decryption process using the extended keys stored in the memory 15 with respect to the ciphertext according to the decryption command, and generates a plain text (decrypted text).

In the conventional encryption/decryption device, to decrease overhead at setting the initial value of the key, the CPU 10 sets the two keys of the encryption key and the decryption key prepared in advance to the memories 11 and 12, initializes a key schedule according to the encryption process or the decryption process of the data, and performs the encryption process or the decryption process. For this reason, the two memories 11 and 12 for the encryption key and the decryption key are needed with respect to one encryption key.

In a method in which the CPU 10 prepares the two keys of the encryption key and the decryption key in advance, when an encryption/decryption device performs an encryption process (or decryption process) of data with respect to a plurality of encryption keys using an engine of a single AES scheme, the CPU 10 needs to the prepare encryption keys and the decryption keys whose number is equal to the number of the encryption keys. For this reason, the CPU 10 may occupy relatively large memory capacities of the memories 11 and 12 to store the encryption keys and the decryption keys. When the encryption keys change, the encryption keys and the decryption keys need to change. Therefore, time may be needed to perform a setting process of the initial values of the encryption keys and the decryption keys, and overhead of the CPU 10 may increase. Reference may be had to, for example, Japanese Patent Application National Publication No. 2007-500376 and Japanese Patent Application Publication (KOKAI) No. 2005-4048.

In the conventional technology, it is difficult to decrease the memory capacity needed to store the encryption key and the decryption key and decrease the overhead of the processor of when the initial value of the encryption key or the decryption key is set.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary chart for explaining an encryption process using an AES scheme;

FIG. 2 is an exemplary chart for explaining a decryption process using an AES scheme;

FIG. 3 is an exemplary chart for explaining a conventional encryption/decryption device;

FIG. 4 is an exemplary chart for explaining an encryption/decryption device according to an embodiment of the invention;

FIG. 5 is an exemplary block diagram of a storage device in the embodiment;

FIG. 6 is an exemplary flowchart of a generation sequence of extended keys in the embodiment;

FIG. 7 is an exemplary flowchart of a sequence of when a process of an L sector is performed without using a CPU in the embodiment;

FIG. 8 is an exemplary chart for explaining an encryption process in CBC mode in the embodiment;

FIG. 9 is an exemplary chart for explaining a decryption process in the CBC mode in the embodiment;

FIG. 10 is an exemplary chart for explaining an encryption process in the CBC mode when a nonce word is encrypted by an encryption key and used as an initialization vector in the embodiment; and

FIG. 11 is an exemplary chart for explaining a decryption process in the CBC mode when a nonce word is encrypted by an encryption key and used as an initialization vector in the embodiment.

### DETAILED DESCRIPTION

Various embodiments according to the invention will be described hereinafter with reference to the accompanying drawings. In general, according to one embodiment of the invention, an encryption device sequentially uses N (N: a natural number not less than 2) extended keys obtained by extending one encryption key in data processing. The encryption device comprises a first memory, a comparison circuit, a second memory, a selector, and an encryption extension calculator. The first memory is configured to store a flag corresponding to an initial value of a key. The comparison circuit is configured to output a comparison result signal indicating a comparison result of matching when a command and the key indicated by the flag stored in the first memory are related to encryption, the command is an encryption command, and the flag indicates the encryption key. The selector is configured to load the key stored in the first memory as an initial value into the second memory, based on the encryption command and a trigger signal, upon receipt of the comparison result signal. The encryption extension calculator is configured to sequentially calculate the extended keys based on the key stored in the second memory and input the extended keys to the selector. Except when loading the initial value of the key into the second memory, the selector is configured to load the extended keys calculated by the encryption extension calculator into the second memory based on the encryption command to extend the encryption key to the extended keys from a first extended key to an N-th extended key.

According to another embodiment of the invention, a decryption device sequentially uses N (N: a natural number not less than 2) extended keys obtained by extending one decryption key in data processing. The decryption device comprises a first memory, a comparison circuit, a second memory, a selector, and a decryption extension calculator. The first memory is configured to store a flag corresponding to an initial value of a key. The comparison circuit is configured to output a comparison result signal indicating a comparison result of matching when a command and the key indicated by the flag stored in the first memory are related to decryption, the command is a decryption command, and the flag indicates the decryption key. The selector is configured to load the key stored in the first memory as an initial value into the second memory, based on the decryption command and a trigger signal, upon receipt of the comparison result signal. The decryption extension calculator is configured to sequentially calculate the extended keys based on the key stored in the second memory and input the extended keys to the selector. Except when loading the initial value of the key into the second memory, the selector is configured to load the extended keys calculated by the decryption extension calculator into the second memory based on the decryption command to extend the decryption key to the extended keys from an N-th extended key to a first extended key.

According to still another embodiment of the invention, a storage device comprises a controller and an encryption and decryption device. The controller is configured to control recording of data on the storage device and reproducing of data from the storage device. The encryption and decryption device is configured to sequentially use N (N: a natural number not less than 2) extended keys obtained by extending one encryption key in data processing, encrypt the data to be recorded on the storage device, and decrypt the data reproduced from the storage device. The encryption and decryption device comprises a first memory, a comparison circuit, a second memory, a selector, an encryption extension calculator, and a decryption extension calculator. The first memory is configured to store a flag corresponding to an initial value of a key. The comparison circuit is configured to output a comparison result signal indicating a comparison result of matching when a command and the key indicated by the flag stored in the first memory are related to encryption, the command is an encryption command, and the flag indicates the encryption key, or when the command and the key are related to decryption, the command is a decryption command, and the flag indicates a decryption key. The selector is configured to load the key stored in the first memory as an initial value into the second memory, based on the command and a trigger signal, upon receipt of the comparison result signal. The encryption extension calculator is configured to sequentially calculate the extended keys based on the key stored in the second memory and input the extended keys to the selector. The decryption extension calculator is configured to sequentially calculate the extended keys based on the key stored in the second memory and input the extended keys to the selector. Except when loading the initial value of the key into the second memory, the selector is configured to load the extended keys calculated by the encryption extension calculator into the second memory based on the encryption command to extend the encryption key to the extended keys from a first extended key to an N-th extended key, and load the extended keys calculated by the decryption extension calculator into the second memory based on the decryption command to extend the decryption key to the extended keys from the N-th extended key to the first extended key.

According to still another embodiment of the invention, an encryption and decryption device sequentially uses N (N: a natural number not less than 2) extended keys obtained by extending one encryption key in data processing. The encryption and decryption device comprises a first memory, a comparison circuit, a second memory, a selector, an encryption extension calculator, and a decryption extension calculator. The first memory is configured to store a flag corresponding to an initial value of a key. The comparison circuit is configured to output a comparison result signal indicating a comparison result of matching when a command and the key indicated by the flag stored in the first memory are related to encryption, the command is an encryption command, and the flag indicates the encryption key, or when the command and the key are related to decryption, the command is a decryption command, and the flag indicates a decryption key. The selector is configured to load the key stored in the first memory as an initial value into the second memory, based on the command and a trigger signal, upon receipt of the comparison result signal. The encryption extension calculator is configured to sequentially calculate the extended keys based on the key stored in the second memory and input the extended keys to the selector. The decryption extension calculator is configured to sequentially calculate the extended keys based on the key stored in the second memory and input the extended keys to the selector. Except when loading the initial value of the key into the second memory, the selector is configured to load the extended keys calculated by the encryption extension calculator into the second memory based on the encryption command to extend the encryption key to the extended keys from a first extended key to an N-th extended key, and load the extended keys calculated by the decryption extension calculator into the second memory based on the decryption command to extend the decryption key to the extended keys from the N-th extended key to the first extended key.

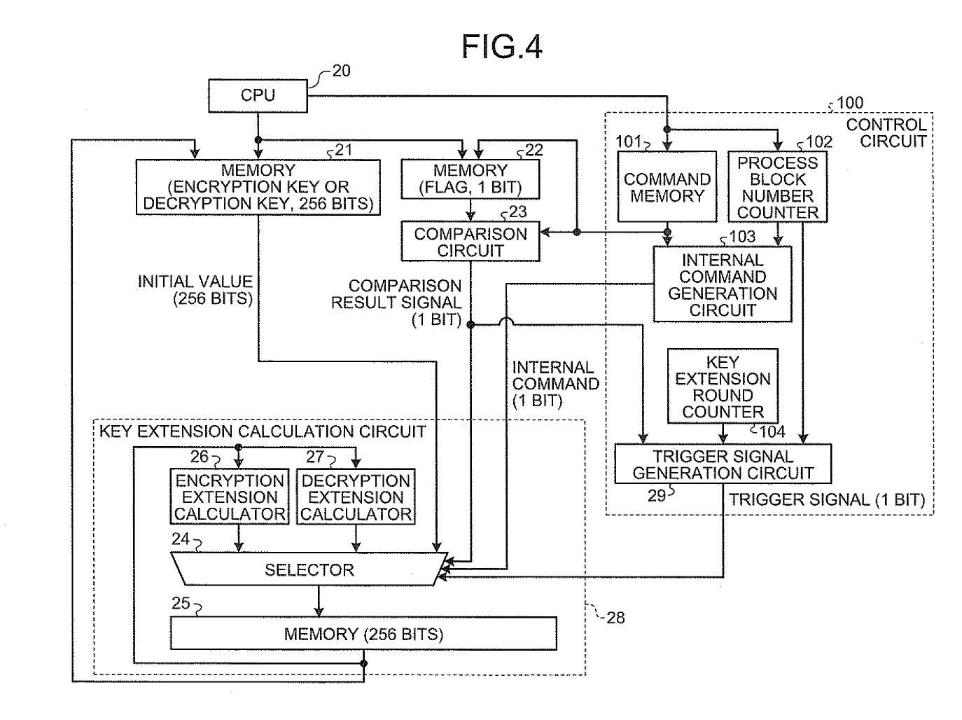

FIG. 4 illustrates an encryption/decryption device according to an embodiment of the invention. For convenience of explanation, it is assumed that the key length of the encryption key and the decryption key is 256 bits. The encryption/decryption device comprises a key extension circuit illustrated in FIG. 4 and an engine (not illustrated) of an AES scheme that performs an encryption process and a decryption process of the AES scheme. The engine of the AES scheme will be described in detail below.

First, a CPU 20 sets an initial value of an encryption key corresponding to an extended key 1 and an extended key 2 to a memory 21, and sets a 1-bit flag indicating that the extended key 1 and the extended key 2 set to the memory 21 are the encryption key to a memory 22. Alternatively, the CPU 20 sets an initial value of a decryption key corresponding to an extended key N−1 and an extended key N to the memory 21, and sets a 1-bit flag indicating that the extended key N−1 and the extended key N set to the memory 21 are the decryption key to the memory 22. The memory 21 may have a memory capacity that can store an initial value of a key schedule. The memory 22 may have a memory capacity that can store the 1-bit flag. The memory 21 stores the initial value of the key schedule set by the CPU 20 or the initial value of the key schedule finally used by the engine of the AES scheme, and the memory 22 stores a flag indicating a state of the memory 21 (indicating which of the initial value of the encryption key and the initial value of the decryption key is stored in the memory 21).

The encryption process starts in response to an encryption command issued by the CPU 20. The decryption process starts in response to a decryption command issued by the CPU 20. The encryption command or the decryption command issued by the CPU 20 is supplied to a control circuit 100.

The control circuit 100 comprises a command memory 101, a process block number counter 102, an internal command generation circuit 103, a key extension round counter 104, and a trigger signal generation circuit 29.

The command memory 101 stores the command issued by the CPU 20 to recognize whether the command issued by the CPU 20 is the encryption command or the decryption command. The process block number counter 102 increments a count, each time an encryption process or a decryption process of data of 128 bits is completed based on the command issued by the CPU 20, and counts a process block from 0 to M (M: a natural number not less than 2). If a count value reaches M, the count value is initialized to 0. When the count value of the process block number counter 102 is in a range of 1 to M−1, the internal command generation circuit 103 executes the command stored in the command memory 101. When the count value of the process block number counter 102 is M, the internal command generation circuit 103 generates a 1-bit internal command that executes a command opposite to the command stored in the command memory 101.

The key extension round counter 104 counts a round of the extended keys 1 to N (i.e., first to N-th extended keys). When the count value of the process block number counter 102 is in a range of 0 to M−1, the trigger signal generation circuit 29 generates a trigger signal in response to an output of a comparison circuit 23, for every N rounds of the extended keys counted by the key extension round counter 104, i.e., every decryption process of data of 128 bits, and outputs the trigger signal to a selector 24 in a key extension calculation circuit 28 to be described in detail below. Meanwhile, when the count value of the process block number counter 102 is M, the trigger signal generated by the trigger signal generation circuit 29 is masked and is not output to the selector 24.

When the encryption process is performed, if a 1-bit encryption command obtained through the command memory 101 from the CPU 20 and the key indicated by the flag stored in the memory 22 are related to the encryption, the comparison circuit 23 outputs a 1-bit comparison result signal indicating that the compared bits match each other to the selector 24. When the decryption process is performed, if a 1-bit decryption command obtained through the command memory 101 from the CPU 20 and the key indicated by the flag stored in the memory 22 are related to the decryption, the comparison circuit 23 outputs a comparison result signal indicating that the compared bits match each other to the selector 24.

When the encryption process is performed, if the selector 24 receives the comparison result signal indicating matching, the selector 24 loads the encryption key stored in the memory 21 as the initial value into a memory 25 according to the encryption command and the 1-bit trigger signal instructing the loading of the initial value into the memory 25, and contents stored in the memories 21 and 22 do not change. The trigger signal is output from the trigger signal generation circuit 29 in response to the output of the comparison circuit 23, as described above. When the encryption process is performed, an encryption extension calculator 26 sequentially calculates the extended keys 1 to N (i.e., first to N-th extended keys) based on the encryption key in the memory 25. In the case other than when the initial value of the key is loaded into the memory 25, the selector 24 loads the extended keys calculated by the encryption extension calculator 26 into the memory 25 according to the encryption command. Therefore, when the encryption process is performed, the encryption key is extended in the order of the extended keys 1 to N.

When the decryption process is performed, if the selector 24 receives the comparison result signal indicating matching, the selector 24 loads the decryption key as the initial value into the memory 25 according to the decryption command and the trigger signal, and contents stored in the memories 21 and 22 do not change. When the decryption process is performed, a decryption extension calculator 27 sequentially calculates the extended keys N to 1 (i.e., N-th to first extended keys) based on the decryption key in the memory 25. In the case other than when the initial value of the key is loaded into the memory 25, the selector 24 loads the extended keys calculated by the decryption extension calculator 27 into the memory 25 according to the decryption command. Therefore, when the decryption process is performed, the decryption key is extended in the order of the extended keys N to 1.

The selector 24, the memory 25, the encryption extension calculator 26, and the decryption extension calculator 27 form the key extension calculation circuit 28.

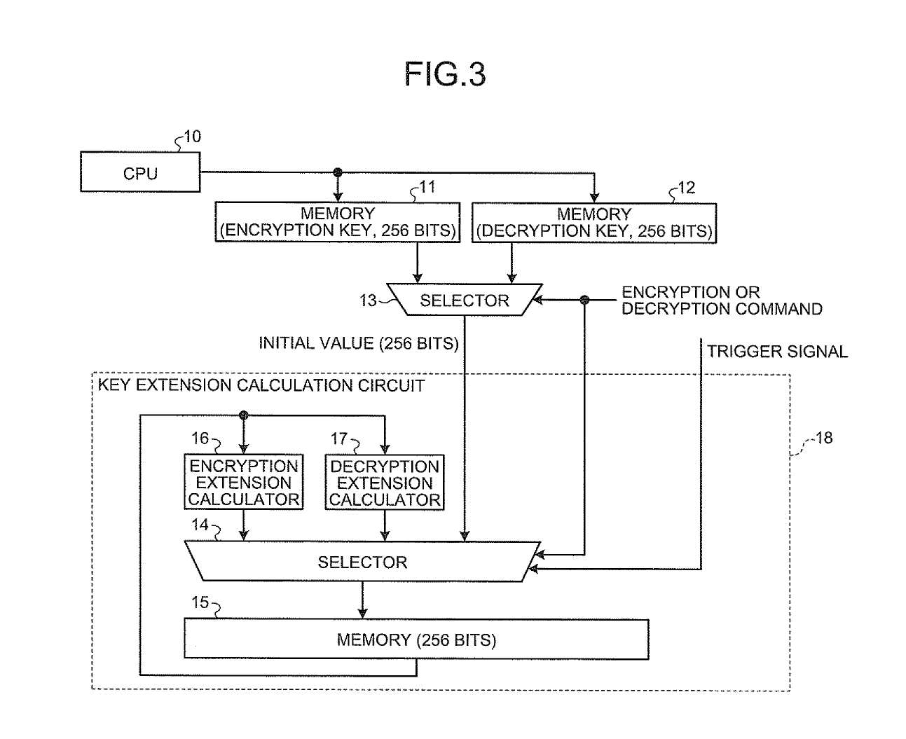

In the conventional device illustrated in FIG. 3, the CPU 10 sets the encryption key and the decryption key to the memories 11 and 12. In the embodiment, however, the CPU 20 may set one of the encryption key and the decryption key and the 1-bit flag indicating whether the key is the encryption key or the decryption key to the memories 21 and 22. Therefore, time needed to set the initial value of the key becomes approximately the half of the time needed in the conventional device, and the memory capacities of the memories 11 and 12 needed to set the initial value of the key become approximately the half of the memory capacities of the memories 11 and 12 needed in the conventional device.

If one of the command issued from the CPU 20 and the key indicated by the flag stored in the memory 22 is related to the encryption and the other is related to the decryption, the comparison circuit 23 outputs a comparison result signal indicating that the compared bits mismatch each other to the selector 24.

When the selector 24 receives the comparison result signal indicating mismatching, if the command issued from the CPU 20 is the encryption command, the selector 24 loads the decryption key stored in the memory 21 as the initial value into the memory 25 in response to the trigger signal. The decryption extension calculator 27 sequentially calculates the extended keys based on the decryption key in the memory 25, and the decryption key is extended in the order of the extended keys N to 1 and the encryption key is obtained. The obtained encryption key is set from the memory 25 to the memory 21, and the flag indicating that the key set to the memory 21 is the encryption key is set from the CPU 20 to the memory 22. As a result, the contents of the memories 21 and 22 are updated with the contents for the encryption process.

When the selector 24 receives the comparison result signal indicating that the compared bits mismatch each other, if the command issued from the CPU 20 is the decryption command, the selector 24 loads the encryption key stored in the memory 21 as the initial value into the memory 25 in response to the trigger signal. The encryption extension calculator 26 sequentially calculates the extended keys based on the encryption key in the memory 25, and the encryption key is extended in the order of the extended keys 1 to N and the decryption key is obtained. The obtained decryption key is set from the memory 25 to the memory 21, and the flag indicating that the key set to the memory 21 is the decryption key is set from the CPU 20 to the memory 22. As a result, the contents of the memories 21 and 22 are updated with the contents for the decryption process.

That is, if the comparison result obtained by the comparison circuit 23 indicates mismatching, the initial value of the key stored in the memory 22 is set to the memory 25, the initial value of the key in the memory 25 obtained by extending the key in the encryption extension calculator 26 or the decryption extension calculator 27 is set to the memory 22, and the flag corresponding to the initial value of the key set to the memory 22 is set to the memory 22. In this way, the contents of the memory 22 are updated. Thus, the update of the flag of the memory 22 does not need to be set by the CPU 20, and can be automatically set by the 1-bit command obtained through the command memory 101 at update timing of the initial value of the key of the memory 21.

As described above, in the embodiment, if one of the command issued from the CPU 20 and the key indicted by the flag stored in the memory 22 is related to the encryption and the other is related to the decryption, the key extension needs to be performed once in the encryption extension calculator 26 or the decryption extension calculator 27 to set the initial value of the key. However, the key extension that needs to be performed even when the key length is 256 bits can be completed with 14 cycles. Since an operation speed of each of the encryption extension calculator 26 and the decryption extension calculator 27 having the known configuration is faster than that of the CPU 20, the key extension needed to set the initial value of the key does not become the overhead of the CPU 20. Accordingly, the overhead of the CPU 20 does not become larger than that in the conventional device by the key extension to needed to set the initial value of the key.

The engine (not illustrated) of the AES scheme performs an encryption process using the extended keys stored in the memory 25 with respect to the plain text according to the encryption command, and generates a ciphertext. The engine of the AES scheme performs a decryption process using the extended keys stored in the memory 25 with respect to the ciphertext according to the decryption command, and generates a plain text (decrypted text).

When the decryption process is performed immediately after the encryption process is performed, if the N-th extended key stored in the memory 25 and used in the encryption process is used as the initial value of the subsequently used decryption key, the overhead of the decryption process can be reduced. Similarly, when the encryption process is performed immediately after the decryption process is performed, if the N-th extended key stored in the memory 25 and used in the decryption process is used as the initial value of the subsequently used decryption key, the overhead of the encryption process can be reduced.

The memories 21 and 22 do not need to be separated memories, and may be configured as a single memory having different memory areas. The initial value of the encryption key or the decryption key and the flag may be processed as one data. The CPU 20 may be allowed to have access to the memory 21 and handle the encryption key or the decryption key as the bit length of the encryption key+1 bit (flag). In this case, the CPU 20 and the key extension calculation circuit 28 can use the encryption key or the decryption key (encryption extended key+1 bit or decryption extended key+1 bit) as a key used as the encryption key and the decryption key. In particular, in the encryption/decryption device that uses the plural encryption keys, when an encryption process and a decryption process are performed using an engine of a single AES scheme, the stored key may be the encryption key or the decryption key. Therefore, the memory capacity needed to set the initial value of the key can be reduced as compared with that of the conventional technology. The key length of the set initial value of the key may be the encryption key+1 bit or the decryption key+1 bit. Therefore, the overhead to set the initial value of the key can be reduced as compared with the conventional technology.

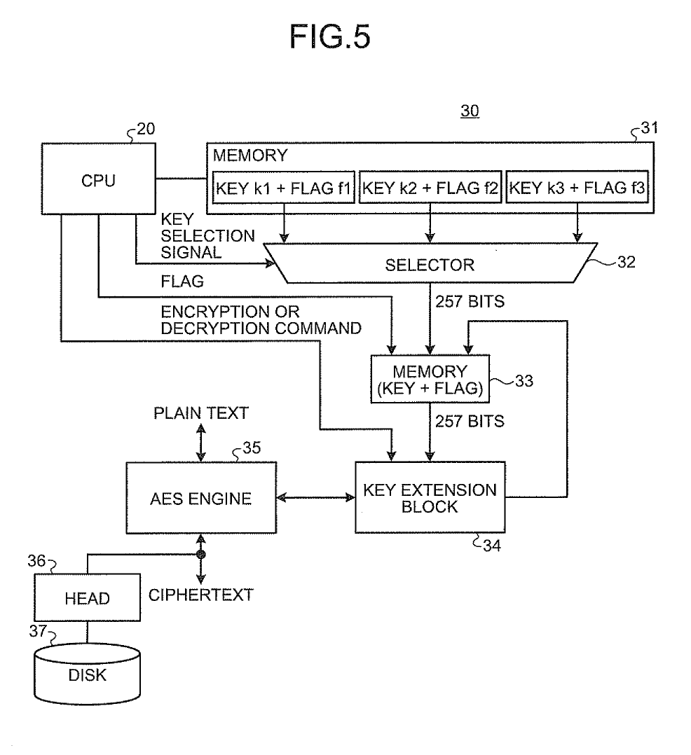

FIG. 5 is a block diagram of the storage device 30 using the engine of the single AES scheme. As illustrated in FIG. 5, the storage device 30 comprises the CPU 20, a memory 31, a selector 32, a memory 33, a key extension block 34, an AES engine 35, a head 36, and a disk 37.

The memory 33 corresponds to the memories 21 and 22 illustrated in FIG. 4. The key extension block 34 corresponds to the comparison circuit 23, the trigger signal generation circuit 29, and the key extension calculation circuit 28 illustrated in FIG. 4, but may further comprise other elements of the control circuit 100. Under the control of the CPU 20 that functions as the controller, the head 36 records information on the disk 37 and reproduces information recorded on the disk 37. The disk 37 may be storage media, such as a magnetic disk, an optical disk or a magneto-optical disk. When the disk 37 is the magnetic disk, the head 36 is moved and controlled to scan the magnetic disk with the predetermined floating amount. However, since the movement and control mechanism of the head 36 is known in a field of a hard disk drive (HDD), the illustration and the description are omitted. The number of each of the heads 36 and the disks 37 may be plural.

In the embodiment, the storage device that is used when the data is recorded and reproduced is formed of the disk device having the head 36 and the disk 37. However, the storage device is not limited to the device using the head, and a semiconductor storage device, such as a flash memory, may be used when the data is recorded and reproduced. Even when the semiconductor storage device is used in recording and reproducing of data, the data is recorded on the storage device and is reproduced from the storage device, under the control of the CPU 20 that functions as the controller.

In the example of FIG. 5, the storage device 30 can select any key from keys k1, k2, and k3 of three kinds, but the number of selectable keys is not limited to 3. The CPU 20 outputs a key selection signal to the selector 32, and sets a flag, which corresponds to a key selected from flags f1, f2, and f3 corresponding to the keys k1, k2, and k3 stored in the memory 31, to the memory 33. When the bits of the command issued from the CPU 20 and the flag stored in the memory 33 match each other, the key extension block 34 loads the key stored in the memory 33 as the initial value into the memory 25 in response to the trigger signal from the trigger signal generation circuit 29. When the key stored in the memory 33 is the encryption key, the encryption extension calculator 26 sequentially calculates the extended keys 1 to N. When the key is the decryption key, the decryption extension calculator 27 sequentially calculates the extended keys N to 1.

Meanwhile, when the bits of the command issued from the CPU 20 and the flag stored in the memory 33 mismatch each other, the key extension block 34 loads the key stored in the memory 33 as the initial value into the memory 25 according to the command issued from the CPU 20 and the trigger signal from the trigger signal generation circuit 29. When the key stored in the memory 33 is the decryption key, the decryption extension calculator 27 sequentially calculates the extended keys N to 1 based on the decryption key. When the key is the encryption key, the encryption extension calculator 26 sequentially calculates the extended keys 1 to N based on the encryption key. Thereby, the obtained encryption key or decryption key is set from the memory 25 to the memory 33, the flag corresponding to the key set to the memory 33 is set, and the contents of the memory 33 are updated.

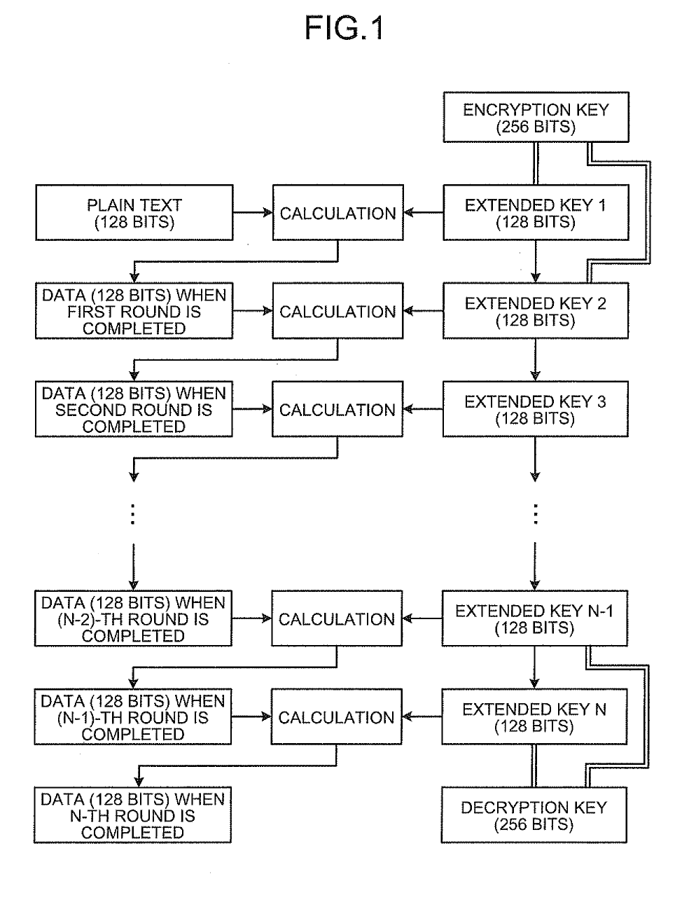

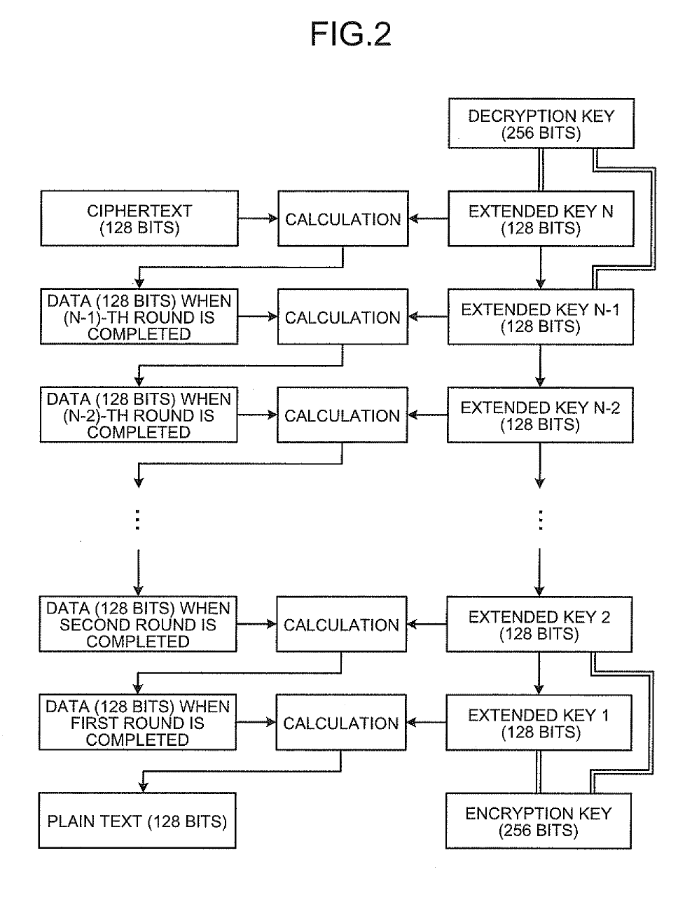

The AES engine 35 performs the encryption process illustrated in FIG. 1 using the extended key stored in the memory 25 in the key extension block 34 with respect to the plain text input from an external device (not illustrated), such as a host device, to the storage device 30 according to the encryption command, and generates a ciphertext. The generated ciphertext is recorded on the disk 37 by the head 36. The AES engine 35 performs the decryption process illustrated in FIG. 2 using the extended key stored in the memory 25 in the key extension block 34 with respect to the ciphertext reproduced from the disk 37 by the head 36 according to the decryption command, and generates a plain text (decrypted text). The generated plain text is output to the external device, such as the host device, from the storage device 30. It is assumed that the AES engine 35 itself has the known configuration.

When the storage device 30 is the HDD, a continuous process of data of several megabits (Mbit) is performed using the same key in the encryption process and the decryption process. This continuous process is realized by repetitively executing the encryption process and the decryption process, as described above.

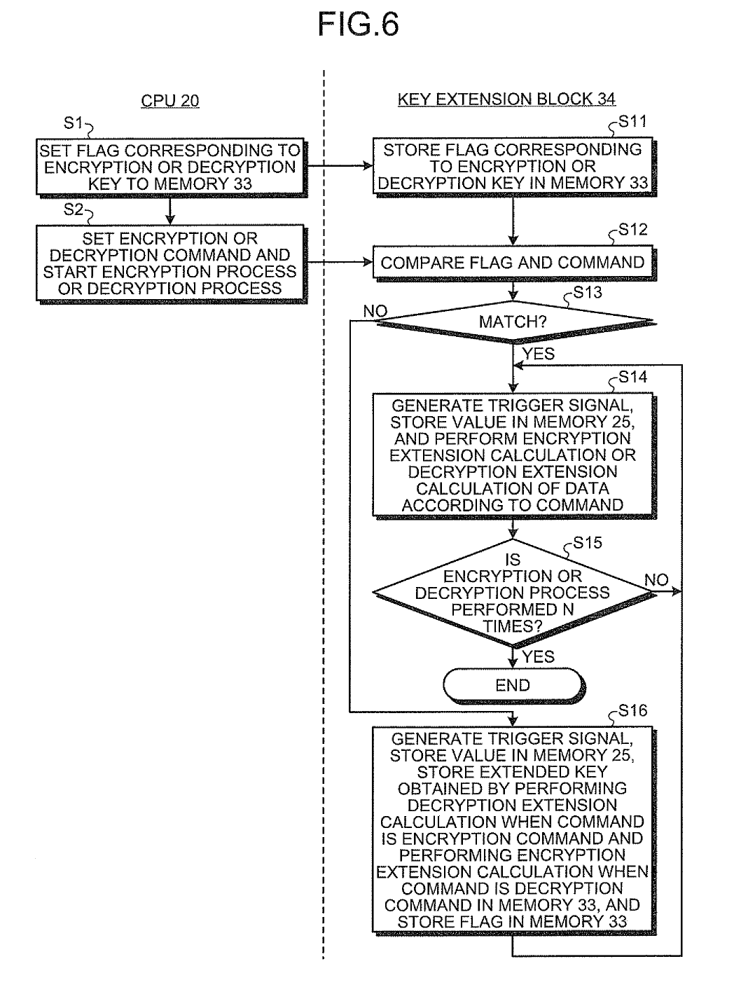

Next, a generation sequence of the extended keys according to the embodiment will be described with reference to FIG. 6. FIG. 6 is a flowchart of a generation sequence of extended keys. In FIG. 6, processes of S1 and S2 are performed by the CPU 20, and processes of S11 to S17 are performed by the key extension block 34.

In the CPU 20, the flag corresponding to the encryption key or the decryption key is set to the memory 33 (S1). Thereby, in the key extension block 34, the flag corresponding to the encryption key or the decryption key is stored in the memory 33 (S11). The CPU 20 issues an encryption command and starts an encryption process or issues a decryption command and starts a decryption process (S2). The key extension block 34 compares the command issued by the CPU 20 and the flag in the memory 33 (S12). The key extension block 34 determines whether the command and the flag match as the comparison result (S13). When they match (YES at S13), the process proceeds to S14. When they do not match (NO at S13), the process proceeds to S16.

The key extension block 34 generates a trigger signal by the trigger signal generation circuit 29, and stores the key in the memory 33 in the memory 25 in response to the trigger signal. The key extension block 34 performs encryption extension calculation of data of 128 bits by the encryption extension calculator 26 when the command issued from the CPU 20 is the encryption command, and performs decryption extension calculation of data of 128 bits by the decryption extension calculator 27 when the command is the decryption command (S14). At this time, the AES engine 35 performs encryption or decryption of data using each extended key and calculates data when a corresponding round is completed. The key extension block 34 determines whether the encryption or decryption process is continuously performed N times (S15). If not (NO at S15), the process returns to 14. When the encryption or decryption process is continuously performed N times (YES at S15), the process ends.

Meanwhile, When the command and the flag do not match (NO at S13), the key extension block 34 generates a trigger signal by the trigger signal generation circuit 29, and stores the key in the memory 33 in the memory 25 in response to the trigger signal. The key extension block 34 performs decryption extension calculation of data of 128 bits by the decryption extension calculator 27 when the command issued from the CPU 20 is the encryption command, and performs encryption extension calculation of data of 128 bits by the encryption extension calculator 26 when the command is the decryption command (S16). At S16, the calculated encryption key or decryption key is stored in the memory 33, and the flag corresponding to the encryption key or the decryption key in the memory 33 is stored in the memory 33. At this time, the AES engine 35 does not perform encryption or decryption of data using each extended key.

Meanwhile, a sequence that is used when the encryption process is performed once immediately after the decryption process may be used in block cipher modes of operation. For example, a cipher block chain (CBC) mode, a method that uses a result obtained by encrypting a nonce word by the same key as an initialization vector is recommended. The initialization vector is an initial value used in first data processing when the CBC mode starts. In the case of a process of data of 128 bits, an initial value is also 128 bits. When the recommended method is applied to the storage device where an encryption process or a decryption process is performed in a sector unit of the HDD and continuous sector write or continuous sector read is performed and the decryption is performed, a series of processes for encrypting a nonce word of 128 bits after decrypting data of 128 bits of a tail of the sector, generating the initialization vector, and decrypting data of 128 bits of a head of a next sector needs to be continuously performed without using the CPU. Meanwhile, when the encryption is performed, the encryption of the initialization vector and the encryption of the sector are performed. Therefore, the AES always performs the encryption. The description of the encryption is omitted herein.

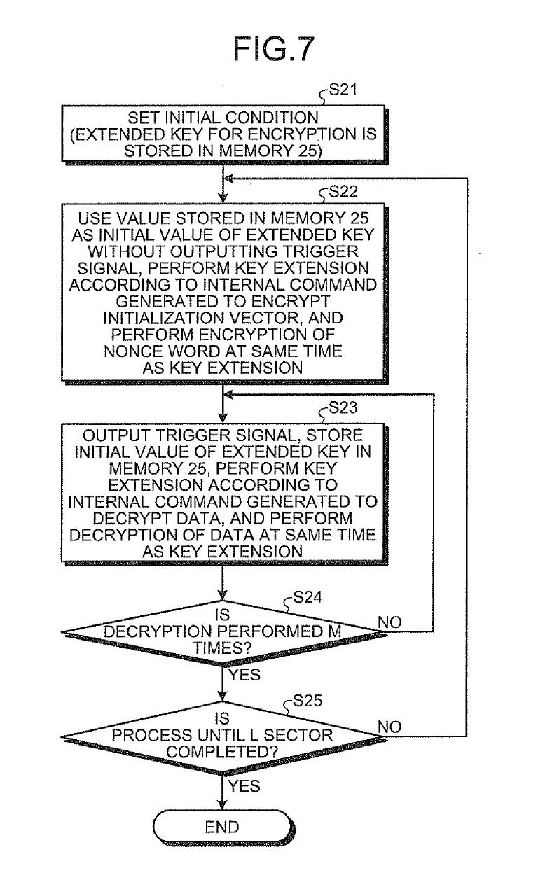

Next, a sequence of when a process of L sectors is performed without using the CPU 20 in the case where a process of one sector is performed by the one-time encryption process of the nonce word and the decryption processes to be continuously performed M times will be described with reference to FIG. 7. FIG. 7 is a flowchart of a sequence of when a process of an L sectors is performed without using the CPU 20.

In FIG. 7, an initial condition is set (S21). Under the initial condition, the contents of the memory 33 (or memories 21 and 22) are initialized for decryption. When the determination result of S13 of FIG. 6 is YES or the process of S16 is completed, it is assumed that the decryption is already performed at least one and the extended keys for the encryption are stored in the memory 25. The trigger signal is not output from the trigger signal generation circuit 29, the value stored in the memory 25 is used as the initial value of the extended key, the key extension is performed based on the encryption extension calculation from the encryption extension calculator 26 according to the internal command generated to encrypt the initialization vector, and the encryption of the nonce word by the AES engine 35 is performed at the same time as the key extension (S22). The trigger signal is output from the trigger signal generation circuit 29, the initial value of the extended key is stored in the memory 25, the key extension is performed based on the decryption extension calculation from the decryption extension calculator 27 according to the internal command generated to decrypt the data, and the decryption of the data by the AES engine 35 is performed at the same time as the key extension (S23).

As described above, when the count value of the process block number counter 102 that counts the process block number is in a range of 0 to M−1, the internal command executes the decryption command set by the CPU 20. When the count value is M, the internal command executes the encryption command. The process block number counter 102 increments a count each time the encryption process or the decryption process of data of 128 bits is completed. When the count value reaches M, the count value of the process block number counter 102 is initialized to 0. When the count value of the process block number counter 102 is in a range of 0 to M−1, the trigger signal generated by the trigger signal generation circuit 29 is output in response to the output of the comparison circuit 23 for every N rounds of the key extension counted by the key extension round counter 104, i.e., the decryption process of data of 128 bits. When the count value of the process block number counter 102 is M, the trigger signal generated by the trigger signal generation circuit 29 is masked and is not output.

The AES engine 35 determines whether the decryption is performed M times (S24). If not (NO at S24), the process returns to S23. When the decryption is performed M times (YES at S24), the AES engine 35 determines whether the process until the L sector is completed (S25). If not NO at S25), the process returns to S22. When the process until the L sector is completed (YES at S25), the process ends.

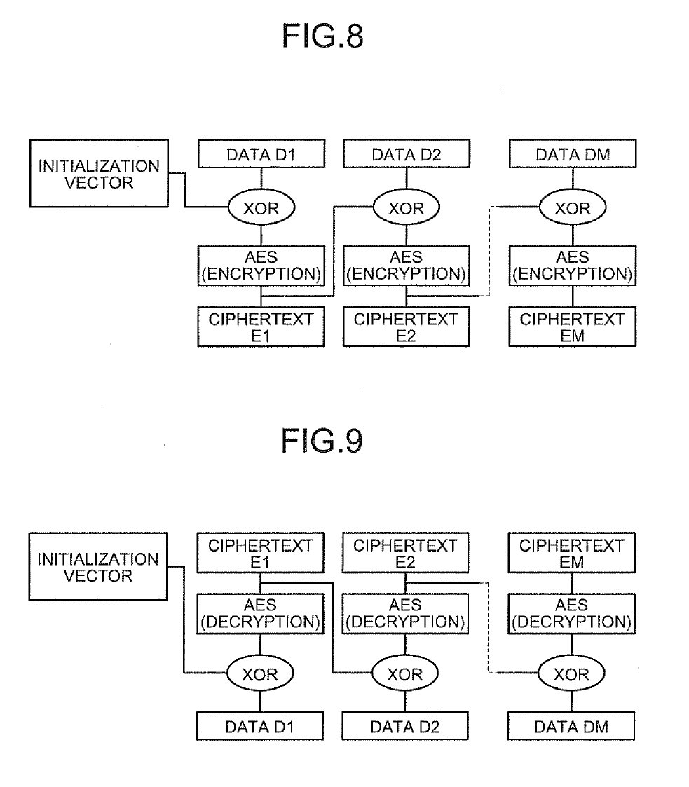

Next, the block cipher modes of operation will be described with reference to FIGS. 8 to 11.

In general, when data of at least 128 bits is encrypted by the same encryption key, a method that is called the block cipher modes of operation is used. As an example of a preferable mode, a mode that is called a CBC mode is used. In the CBC mode, the process of one sector is performed according to the sequence illustrated in FIG. 8 in the case of the encryption process, and is performed according to the sequence illustrated in FIG. 9 in the case of the decryption process.

FIG. 8 illustrates an encryption process in the CBC mode. In FIG. 8, data D1 is subjected to an XOR (eXclusive-OR) operation with the initialization vector and subjected to the encryption of the AES scheme, and a ciphertext E1 is obtained. Data 2 is subjected to an XOR operation with the ciphertext E1 and subjected to the encryption of the AES scheme, and a ciphertext E2 is obtained. Hereinafter, the same process is repeated. Finally, data DM is subjected to an XOR operation with a ciphertext EM-1 and subjected to the encryption of the AES scheme, and a ciphertext EM is obtained.

FIG. 9 illustrates a decryption process in the CBC mode. In FIG. 9, the ciphertext E1 is subjected to the decryption of the AES scheme and subjected to an XOR operation with the initialization vector, and the data D1 is obtained. The ciphertext E2 is subjected to the decryption of the AES scheme and subjected to an XOR operation with the ciphertext E1, and the data D2 is obtained. Hereinafter, the same process is repeated. Finally, the ciphertext EM is subjected to the decryption of the AES scheme and subjected to an XOR operation with the ciphertext EM-1, and the data DM is obtained.

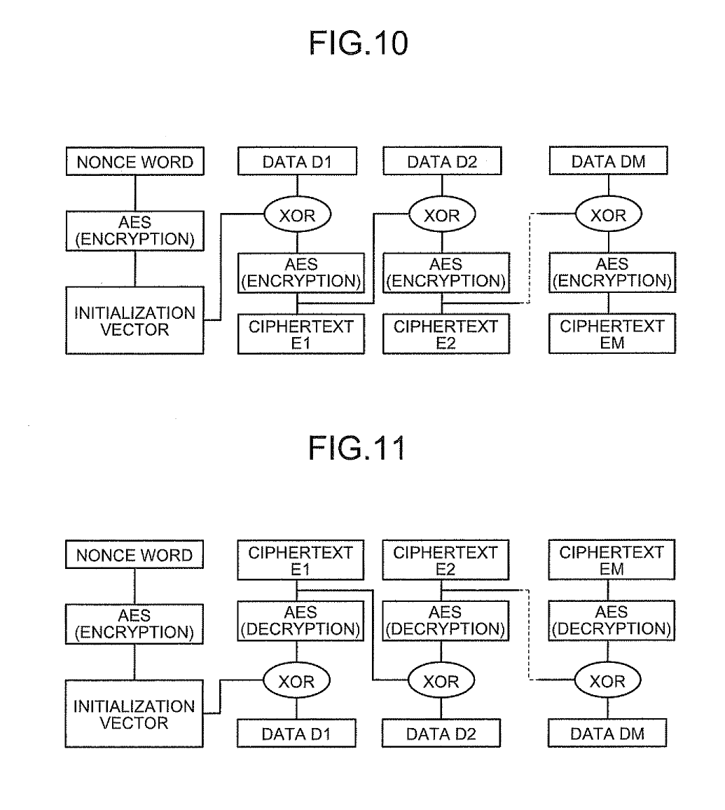

As a recommended generation method of an initialization vector, a method that encrypts the nonce word by the encryption key and uses the nonce word as the initialization vector is exemplified. In this case, the process of one sector in the CBC mode is performed according to the sequence illustrated in FIG. 10 in the case of the encryption process, and is performed according to a sequence illustrated in FIG. 11 in the case of the decryption process.

FIG. 10 illustrates the encryption process in the CBC mode, when the nonce word is encrypted by the encryption key and used as the initialization vector. In FIG. 10, the nonce word is subjected to the encryption of the AES scheme and becomes the initialization vector. The initialization vector is used in the encryption, similar to the case of FIG. 8.

FIG. 11 illustrates the decryption process in the CBC mode, when the nonce word is encrypted by the encryption key and used as the initialization vector. In FIG. 11, the nonce word is subjected to the encryption of the AES scheme and becomes the initialization vector. The initialization vector is used in the decryption, similar to the case of FIG. 9.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An encryption device configured to use N extended keys extended from one encryption key where N is a natural number not smaller than 2, the encryption device comprising:
a first memory configured to store a flag corresponding to an initial value of a key;
a comparison circuit configured to output a comparison result signal indicating whether the flag and a command correspond when the command is an encryption command and the key indicated by the flag in the first memory is the encryption key;
a second memory;
a first selector configured to load the encryption key in the first memory as an initial value into the second memory, based on the encryption command, a trigger signal, and the comparison result signal; and
an encryption extension calculator configured to calculate the extended keys based on the encryption key in the second memory and to transmit the extended keys to the first selector,
wherein the first selector is configured to load the initial value of the encryption key into the second memory for a first time, and to load the extended keys into the second memory after the first time, if the encryption command instructs the encryption device to extend the encryption key into the extended keys in an order from a first extended key to an N-th extended key.

2. The encryption device of claim 1, further comprising a trigger signal generator configured to generate the trigger signal based on the comparison result signal.

3. The encryption device of claim 1, further comprising a processor configured to issue the encryption command and to set the flag corresponding to the initial value of the encryption key to the first memory.

4. The encryption device of claim 1, wherein the first memory comprises a memory configured to store the initial value of the encryption key and to output the initial value of the encryption key to the first selector, and a memory configured to store the flag and to output the flag to the comparison circuit.

5. The encryption device of claim 1, further comprising:
a processor configured to issue the command and to set a plurality of pairs of flags corresponding to the initial value of the encryption key to a third memory; and
a second selector configured to set one of the pairs of flags corresponding to the initial value of the encryption key to the first memory based on a key selection signal issued by the processor.

6. The encryption device of claim 1, further comprising an advanced encryption standard engine configured to encrypt data by the first extended key to the N-th extended key in the second memory.

7. A decryption device configured to use N extended keys from one decryption key where N is a natural number not smaller than 2, the decryption device comprising:
a first memory configured to store a flag corresponding to an initial value of a key;
a comparison circuit configured to output a comparison result signal indicating whether the flag and a command correspond when the command is a decryption command and the key indicated by the flag in the first memory is the decryption key;
a second memory;
a first selector configured to load the decryption key in the first memory as an initial value into the second memory, based on the decryption command, a trigger signal and the comparison result signal; and
a decryption extension calculator configured to calculate the extended keys based on the decryption key in the second memory and to transmit the extended keys to the first selector,
wherein the first selector is configured to load the initial value of the key into the second memory for a first time and to load the extended keys into the second memory after a first time, if the decryption command instructs the decryption device to extend the decryption key into the extended keys in an order from an N-th extended key to a first extended key.

8. The decryption device of claim 7, further comprising a trigger signal generator configured to generate the trigger signal based on the comparison result signal.

9. The decryption device of claim 7, further comprising a processor configured to issue the decryption command and to set the flag corresponding to the initial value of the decryption key to the first memory.

10. The decryption device of claim 7, wherein the first memory comprises a memory configured to store the initial value of the decryption key and to output the initial value of the decryption key to the first selector, and a memory configured to store the flag and to output the flag to the comparison circuit.

11. The decryption device of claim 7, further comprising:
a processor configured to issue the command and to set a plurality of pairs of flags corresponding to the initial value of the decryption key to a third memory; and
a second selector configured to set one of the pairs of flags corresponding to the initial value of the decryption key to the first memory based on a key selection signal issued by the processor.

12. The decryption device of claim 7, further comprising an advanced encryption standard engine configured to decrypt data by the N-th extended key to the first extended key in the second memory.

13. A storage device comprising:
a controller configured to control recording of data on the storage device and reproducing of data from the storage device; and
an encryption and decryption device configured to use N extended keys from one encryption key, to encrypt the data to be recorded on the storage device, and to decrypt the data reproduced from the storage device where N is a natural number not smaller than 2,
wherein the encryption and decryption device comprises
a first memory configured to store a flag corresponding to an initial value of a key,
a comparison circuit configured to output a comparison result signal indicating whether the flag and a command correspond, the command being an encryption command and the key being indicated by the flag being the encryption key when a command and the key indicated by the flag stored in the first memory are related to encryption, or the command being a decryption command and the key indicated by the flag being a decryption key when the command and the key are related to decryption,
a second memory,
a first selector configured to load the key in the first memory as an initial value into the second memory, based on the command, a trigger signal, and the comparison result signal,
an encryption extension calculator configured to calculate the extended keys based on the key in the second memory and to transmit the extended keys to the first selector, and
a decryption extension calculator configured to calculate the extended keys based on the key in the second memory and to transmit the extended keys to the first selector,
wherein the first selector is configured to load the initial value of the key into the second memory for a first time, to load the extended keys calculated by the encryption extension calculator into the second memory after the first time, if the encryption command instructs the storage device to extend the encryption key into the extended keys in an order from a first extended key to an N-th extended key, and to load the extended keys calculated by the decryption extension calculator into the second memory after the first time if the decryption command instructs the encryption device to extend the decryption key into the extended keys in an order from the N-th extended key to the first extended key.

14. The storage device of claim 13, wherein the encryption and decryption device further comprises a trigger signal generator configured to generate the trigger signal based on the comparison result signal.

15. The storage device of claim 13, further comprising a processor configured to issue the command and to set the flag corresponding to the initial value of the key to the first memory.

16. The storage device of claim 13, wherein the first memory comprises a memory configured to store the initial value of the key and to output the initial value of the key to the first selector, and a memory configured to store the flag and to output the flag to the comparison circuit.

17. The storage device of claim 13, further comprising:
a processor configured to issue the command and to set a plurality of pairs of flags corresponding to the initial value of the key to a third memory; and
a second selector configured to set one of the pairs of flags corresponding to the initial value of the key to the first memory based on a key selection signal issued by the processor.

18. The storage device of claim 13, further comprising an advanced encryption standard engine configured to encrypt data by the first extended key to the N-th extended key in the second memory, and to decrypt data by the N-th extended key to the first extended key in the second memory.

19. The storage device of claim 15, wherein, the initial value of the key in the first memory is set to the second memory when the comparison result indicates mismatching,
the initial value of the key in the second memory from key extension by the encryption extension calculator or the decryption extension calculator is set to the first memory when the comparison result indicates mismatching, and
the flag corresponding to the initial value of the key set to the first memory is set to the first memory in order to update the first memory when the comparison result indicates mismatching.

20. The storage device of claim 17, wherein, the initial value of the key in the first memory is set to the second memory when the comparison result indicates mismatching,
the initial value of the key in the second memory from key extension by the encryption extension calculator or the decryption extension calculator is set to the first memory when the comparison result indicates mismatching, and
the flag corresponding to the initial value of the key set to the first memory is set to the first memory in order to update the first memory when the comparison result indicates mismatching.

21. An encryption and decryption device configured to use N extended keys from one encryption key where N is a natural number not smaller than 2, the encryption and decryption device comprising:
a first memory configured to store a flag corresponding to an initial value of a key;
a comparison circuit configured to output a comparison result signal indicating whether the flag and a command correspond, the command being an encryption command, and the key indicated by the flag being the encryption key when a command and the key indicated by the flag stored in the first memory are related to encryption, or the command being a decryption command and the key indicated by the flag being a decryption key when the command and the key are related to decryption;
a second memory;
a selector configured to load the key in the first memory as an initial value into the second memory, based on the command, a trigger signal, and the comparison result signal;
an encryption extension calculator configured to calculate the extended keys based on the key in the second memory and to transmit the extended keys to the selector; and
a decryption extension calculator configured to calculate the extended keys based on the key in the second memory and to transmit the extended keys to the selector,
wherein the selector is configured to load the initial value of the key into the second memory for a first time, to load the extended keys calculated by the encryption extension calculator into the second memory after the first time, if the encryption command instructs the encryption and decryption device to extend the encryption key into the extended keys in an order from a first extended key to an N-th extended key, and to load the extended keys calculated by the decryption extension calculator into the second memory after the first time, if the decryption command instructs the encryption and decryption device to extend the decryption key into the extended keys in an from the N-th extended key to the first extended key.
